(19) United States
(12) Patent Application Publication
(10) Pub. No.: US 2007/0060219 A1
(43) Pub. Date: Mar. 15, 2007

(54) Sliding shell

(76) Inventors: Hung-Chih Lin, Sindian City (TW); Shun-Fan Cheng, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/221,741

(22) Filed: Sep. 9, 2005

(51) Int. Cl. H04M 1/00

(52) U.S. Cl. 455/575.4

(57) ABSTRACT

A sliding shell comprises a first shell body with a first surface, a first interface layer formed by coating a smooth material on the first surface, a first sliding assembly formed on the first surface of the first shell body, a second shell body with a second surface, and a second sliding assembly formed on the second surface of the second shell body. The second sliding. assembly is correspondingly connected to the first sliding assembly to allow the first shell body sliding between the first position and the second position on the second shell body. In addition, the first interface layer overlaps the second surface, and thus the first interface layer can make the sliding between two shell bodies with benefits of smooth sliding and abrasion prevention.

### TECHNICAL FIELD

This invention relates generally to a technology for a sliding shell on a slide-type mobile phone, and particularly to a sliding shell with a smooth slide and abrasion durability.

### BACKGROUND OF THE INVENTION

A conventional sliding shell on a slide-type mobile phone is usually composed of two plastic shells. The two plastic shells are combined by a set of guideway mechanism for being capable to slide relatively. The opposite combined surfaces of the two plastic shells are directly overlapped and contacted according to the requirement of appearance and quality of the mobile phone. Thus, there will be a certain level of friction force generated between the two plastic shells during sliding that would not only cause the sliding of the two plastic shells not smoothly, but also be liable to leave the abrasive marks on the surfaces of the two plastic shells that affects the appearance of the mobile phone.

Currently, the method for solving the large friction resistance causing not smoothly sliding is to improve the flatness of surfaces between two plastic shells, or to lay on lubricants on the guideway. However, even the above-mentioned method can reduce the friction resistance, it will still exists with the abrasive marks. While improving the flatness of surfaces between two shells, both of the unfavorable products and the cost of the products will increase accordingly.

Moreover, currently for preventing the occurrence of abrasive marks approximately have two methods: the first method is to increase the gap between two plastic shells, and the second method is to attach a protection sheet between two plastic sheets. However, the two methods will both increase the gap between two plastic shells to affect the appearance impression. Furthermore, the protection sheet applied to the second method increases the friction resistance to cause the sliding of two plastic shells further not smoothly.

### SUMMARY OF INVENTION

The primary objective of the present invention is to provide a sliding shell with a smooth sliding and more abrasion durability. The structure of the sliding shell comprises a first shell body having a first surface, a first interface layer formed by coating a smooth material on the first surface, a first sliding assembly formed on the first surface of the first shell body, a second shell body having a second surface, and a second sliding assembly formed on the second surface of the second shell body and connected with the first sliding assembly correspondingly to allow the first shell body sliding between the first position and the second position on the second shell body. In addition, the first interface layer overlaps the second surface when the first and second shell bodies are connected as a relatively sliding status via the first and second sliding assemblies.

Thus, when the first shell body is sliding on the second shell body, the first interface layer reduces the sliding resistance and prevents the occurrence of abrasive marks, so as to have the benefits of smooth sliding and abrasion prevention.

### BRIEF DESCRIPTION OF DRAWINGS

The invention will be more clearly understood after referring to the following detailed description read in conjunction with the drawings wherein:

FIG. 1 is an exploded perspective view of a first embodiment of the present invention;

FIG. 2 is a perspective view of the first embodiment of the present invention;

FIG. 3 is a side view of the first embodiment of the present invention, showing a movement of the first embodiment;

FIG. 4 is an exploded perspective view of a second embodiment of the present invention; and

FIG. 5 is an exploded perspective view of a third embodiment of the present invention.

### DETAILED DESCRIPTION OF PREFERRED EMBODIMENTS

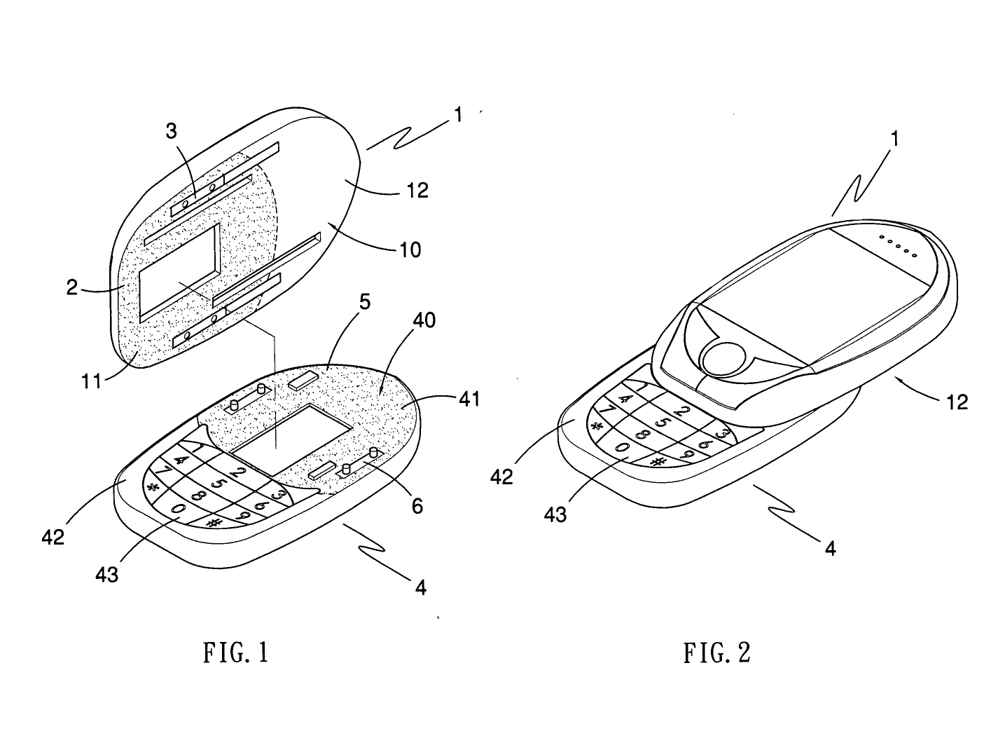

FIG. 1 shows a first preferred embodiment of the present invention, which is a sliding shell applied on slide-type mobile phone and the sliding shell comprises a first shell body 1, a first interface layer 2, a first sliding assembly 3, a second shell body 4, a second interface layer 5, and a second sliding assembly 6.

The first shell body 1 has a first surface 10, which has a connecting area 11 and a protrusive area 12 thereon. Furthermore, the first interface layer 2 is formed by coating a smooth material on the connecting area 11 of the first surface 10, and the smooth material is a Teflon material. In addition, the first sliding assembly 3 is formed on the first surface 10 of the first shell body 1. The second shell body 4 has a second surface 40, which has a supporting area 41 and an exposed area 42 thereon, and the exposed area 42 has a plurality of buttons (43) thereon.

Moreover, the second interface layer 5 is formed by coating a smooth material on the supporting area 41 of the second surface 40, and the smooth material is also a Teflon material. The second sliding assembly 6 is formed on the second surface 40 of the second shell body 4 and connected with the first sliding assembly 3 correspondingly, so as to allow the first shell body 1 sliding between a first position and a second position on the second shell body.

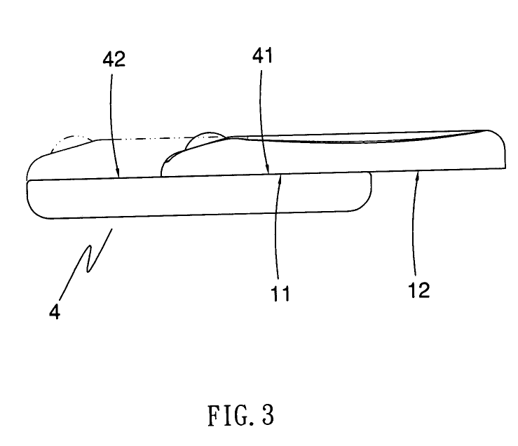

FIG. 2 and FIG. 3 show that when the first shell body 1 slides to the second position, the connecting area 11 overlaps the supporting area 41 of the second shell body 4, and the exposed area 42 is exposed to the first shell body 1, and the protrusive area 12 of the first shell body 1 is relatively protruded to the second shell body 4; furthermore, when the first shell body 1 is at the first position, the connecting area 11 overlaps the exposed area 42 of the second shell body 4 and the protrusive area 12 overlaps the supporting area accordingly.

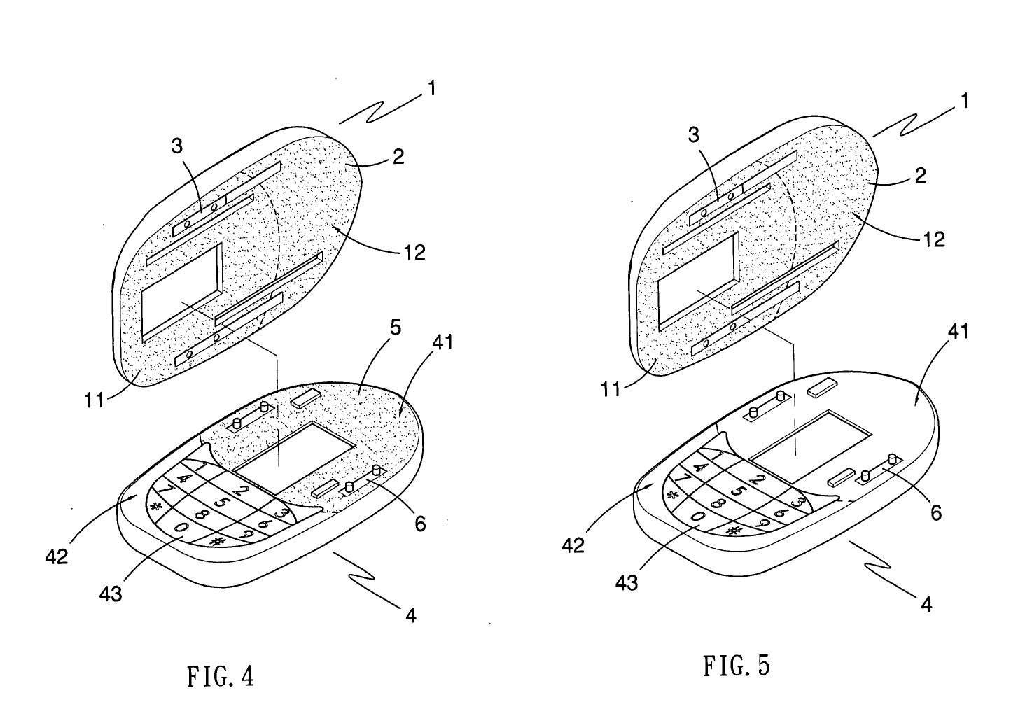

A second preferred embodiment of the present invention is shown in FIG. 4 and the second preferred embodiment is similar to the first preferred embodiment except the first interface layer 2. In FIG. 4, the first interface layer 2 of the second preferred embodiment is formed on the connecting area 11 and the protrusive area 12 of the first shell body 1, and the second interface layer 5 is formed on the supporting area 41 of the second shell body 4.

FIG. 5 shows a third preferred embodiment of the present invention, which is also similar to the first preferred embodiment. The only difference is that the first interface layer 2 of the third preferred embodiment is formed on the connecting area 11 and the protrusive area 12 of the first shell body 1, and the second shell body 4 is not coated with the second interface layer 5.

Furthermore, in order to further improve the smooth sliding between the first shell body 1 and the second shell body 4, at least one of the first sliding assembly 3 and the second sliding assembly 6 is coated with the Teflon material thereon.

When the first shell body 1 is sliding on the second shell body 4, the sliding resistance to both first shell body 1 and the second shell body 4 is reduced by the first interface layer 2 and the second interface layer 5 that assist the sliding. Furthermore, the first interface layer 2 and the second interface layer 5 form protection layers for protecting the first surface 10 of the first shell body 1 and the second surface 40 of the second shell body 4 to greatly reduce the abrasive marks during sliding, because they are smooth and/or wear-resistance materials.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. A sliding shell comprising:
a first shell body, having a first surface;
a first interface layer, formed by coating a smooth material on the first surface of the first shell body;
a first sliding assembly, formed on the first surface of the first shell body;
a second shell body, having a second surface; and
a second sliding assembly, formed on the second surface of the second shell body and connected with the first sliding assembly correspondingly, so as to allow the first shell body sliding between a first position and a second position on the second shell body;
wherein, the first interface layer overlaps the second surface of the second shell body when the first and the second shell bodies are connected as a relatively sliding status via the first and second sliding assemblies.

2. The sliding shell of claim 1, wherein:
the first surface of the first shell body has a connecting area and a protrusive area; and
the second surface of the second shell body has a supporting area and an exposed area, and when the first shell body is at the second position, the connecting area overlaps the supporting area and the exposed area is exposed to the first shell body and the protrusive area is relatively protruded to the second shell body, and when the first shell body is at the first position, the connecting area overlaps the exposed area and the protrusive area overlaps the supporting area.

3. The sliding shell of claim 2, further comprising a second interface layer formed by coating a smooth material on the second surface of the second shell body.

4. The sliding shell of claim 3, wherein the first interface layer is formed on the connecting area.

5. The sliding shell of claim 3, wherein the second interface layer is formed on the supporting area.

6. The sliding shell of claim 4, wherein the second interface layer is formed on the supporting area.

7. The sliding shell of claim 5, wherein the first interface layer is further formed on the protrusive area.

8. The sliding shell of claim 6, wherein the first interface layer is further formed on the protrusive area.

9. The sliding shell of claim 3, wherein the exposed area has a plurality of buttons.

10. The sliding shell of claim 1, wherein the smooth material is a Teflon material.

11. The sliding shell of claim 3, wherein the smooth material is a Teflon material.

12. The sliding shell of claim 1, wherein at least one of the first sliding assembly and the second sliding assembly is coated with a Teflon material thereon.

13. The sliding shell of claim 3, wherein at least one of the first sliding assembly and the second sliding assembly is coated with a Teflon material thereon.
